(19) United States
(12) Patent Application Publication
(10) Pub. No.: US 2026/0107102 A1
(43) Pub. Date: Apr. 16, 2026

(54) MEMS MICROPHONE CHIP

(71) Applicant: AAC ACOUSTIC TECHNOLOGIES (SHENZHEN) CO., LTD., Shenzhen (CN)

(72) Inventors: Bo Li, Shenzhen (CN); Kaijie Wang, Shenzhen (CN); Zhuanzhuan Zhao, Shenzhen (CN); Yu Chen, Singapore (SG); Rui Zhang, Shenzhen (CN)

(21) Appl. No.: 18/963,563

(22) Filed: Nov. 28, 2024

Related U.S. Application Data
(63) Continuation of application No. PCT/CN2024/124852, filed on Oct. 15, 2024.

(51) Int. Cl. H04R 31/00; H04R 7/04; H04R 19/04

(52) U.S. Cl. CPC H04R 31/003; H04R 7/04; H04R 19/04; H04R 2201/003

(57) ABSTRACT

The present disclosure discloses an MEMS microphone chip including a diaphragm having a support portion fixed on the substrate, a main body portion located above the back cavity, and a deflation valve spaced apart from the main body portion for forming a first deflation slit. The deflation valve includes at least one deflation plates. Each of the at least one deflation plates includes a fixation portion connected with the main body portion, a move portion arranged at an interval from the main body portion, and a connection portion connected with the fixation portion and the move portion. A width of the fixation portion is smaller than a width of the move portion. The MEMS microphone chip in the present disclosure has higher reliability.

### FIELD OF THE PRESENT DISCLOSURE

The present disclosure relates to acoustic-electric conversion technologies, especially relates to an MEMS microphone chip.

### DESCRIPTION OF RELATED ART

MEMS microphone chip as an important acoustic component in portable electronics is served to achieve conversion between electric signal and acoustic signal.

In related art, the MEMS microphone chips are prone to damage under high pressure airflow, thereby reducing the performance and the reliability of the MEMS microphone chip. Thereby, a venting structure is provided on the diaphragm to improve the performance and the reliability under high pressure airflow. However, due to the repeatedly open and close of the venting structure under the air pressure, stress concentration is prone to occur at the fixation location of the venting structure, resulting in its damage and thus reducing the reliability of MEMS microphone chips.

Therefore, it is necessary to provide an improved MEMS microphone chip to overcome the problems mentioned above.

### SUMMARY OF THE INVENTION

One object of the present disclosure is to provide an MEMS microphone chip with higher reliability under high pressure airflow.

An MEMS microphone chip including: a substrate having a back cavity; a diaphragm mounted on the substrate and located above the back cavity, including: a main body portion located above the back cavity; a support portion surrounding the main body portion and mounted on the substrate; and a deflation valve spaced apart from the main body portion for forming a first venting slit; a back plate spaced apart from the diaphragm along a vibration direction forming an inner cavity there between; wherein the deflation valve includes at least one deflation plates; each of the at least one the deflation plates includes a fixation portion connected with the main body portion, a move portion arranged at an interval from the main body portion, and a connection portion connected with the fixation portion and the move portion; a width of the fixation portion is smaller than a width of the move portion.

As an improvement, the back plate includes a stop portion extended from a surface facing the diaphragm towards the diaphragm; the stop portion is arranged opposite to the deflation valve.

As an improvement, the connection portion is in an arc shape.

As an improvement, the at least one deflation plates includes two deflation plates; the two deflation plates are arranged at an interval in a rotationally symmetrical manner.

As an improvement, the connection portion includes a first connection portion fixed to the fixation portion, a second connection portion fixed to the move portion, and a third connection portion connected with the first connection portion and the second connection portion; the second connection portions of the two deflation plates are configured to contact with each other to achieve self-lock when the deflation valve moves towards the back plate.

As an improvement, a width of the third connection portion is smaller than a width of the first connection portion and a width of the second connection portion.

As an improvement, the diaphragm includes a plurality of deflation valves spaced apart from each other and arranged in an annular shape.

As an improvement, the diaphragm further includes a second venting slit penetrating thereon; the second venting slit is communicated with the first venting slit.

As an improvement, a structural strength of the deflation plate is greater than a structural strength of the main body portion.

### BRIEF DESCRIPTION OF THE DRAWINGS

The accompanying drawings illustrate embodiments and constitute part of the specification, and together with the specification, serve to explain exemplary embodiments of the present disclosure. The accompanying drawings shown are only for illustrative purposes and do not limit the scope of the claims. In all the accompanying drawings, same reference signs refer to similar but not necessarily identical elements.

FIG. 1 is a schematic diagram of an MEMS microphone chip in accordance with first exemplary embodiment of the present disclosure.

FIG. 2 is a section view of the MEMS microphone chip taken along line A-A in FIG. 1.

FIG. 3 is a schematic diagram of a deflation valve of MEMS microphone chip under airflow.

FIG. 4 is a top view of a diaphragm of the MEMS microphone chip in FIG. 1.

FIG. 5 is an enlarged view of part B in FIG. 4.

FIG. 6 is a top view of a diaphragm of the MEMS microphone chip in accordance with another exemplary embodiment of the present disclosure.

FIG. 7 is an enlarged view of part C in FIG. 6.

FIG. 8 is a top view of a diaphragm of the MEMS microphone chip in accordance with another exemplary embodiment of the present disclosure.

FIG. 9 is an enlarged view of part D in FIG. 8.

### DETAILED DESCRIPTION OF THE EXEMPLARY EMBODIMENTS

In order to make the inventive objectives, features, and advantages of the present disclosure more understandable, the technical solutions in embodiments of the present disclosure will be described clearly and completely below with reference to the accompanying drawings in the embodiments of the present disclosure. It is apparent that the described embodiments are merely some of rather than all of the embodiments of the present disclosure. All other embodiments acquired by those skilled in the art without creative efforts based on the embodiments in the present disclosure shall fall within the protection scope of the present disclosure.

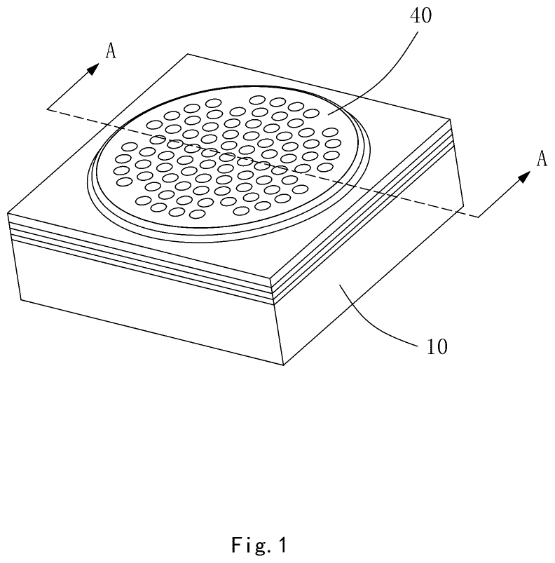

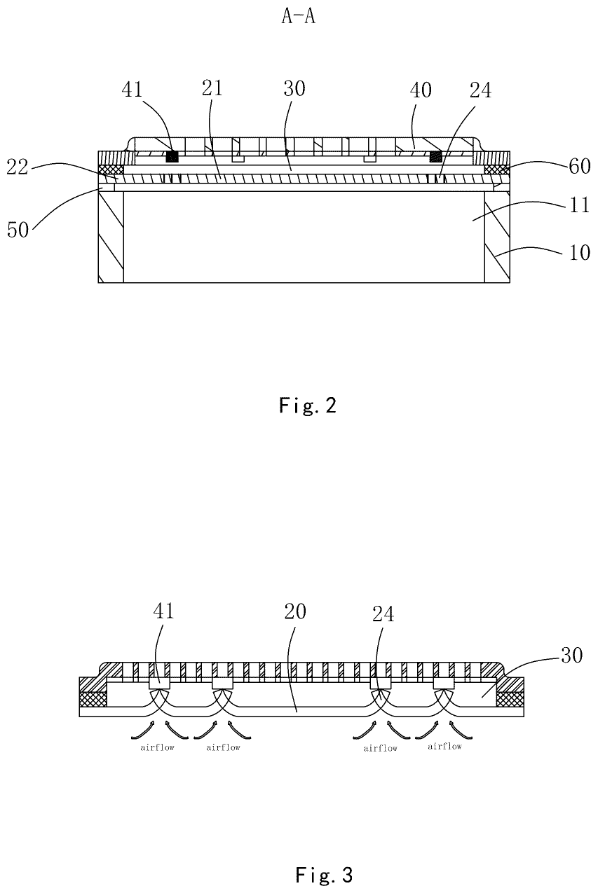

Please refer to FIGS. 1-2, an MEMS microphone chip 100 provided by an exemplary embodiment of the present disclosure includes a substrate 10 having a back cavity 11, a diaphragm 20 mounted on the substrate 10 and located above the back cavity 11, and a back plate 40 spaced apart from the diaphragm 20 along a vibration direction forming an inner cavity 30 there between. In one embodiment, the back plate 40 is located on a side of the diaphragm 20 away from the substrate 10. The MEMS microphone chip 100 further includes a first support portion 50 arranged between the substrate 10 and the diaphragm 20, and a second support portion 60 arranged between the diaphragm 20 and the back plate 40. The first support portion 50 is configured to support the diaphragm 20 above the back cavity 11. The inner cavity 30 is formed between the diaphragm 20, the back plate 40 and the second support portion 60.

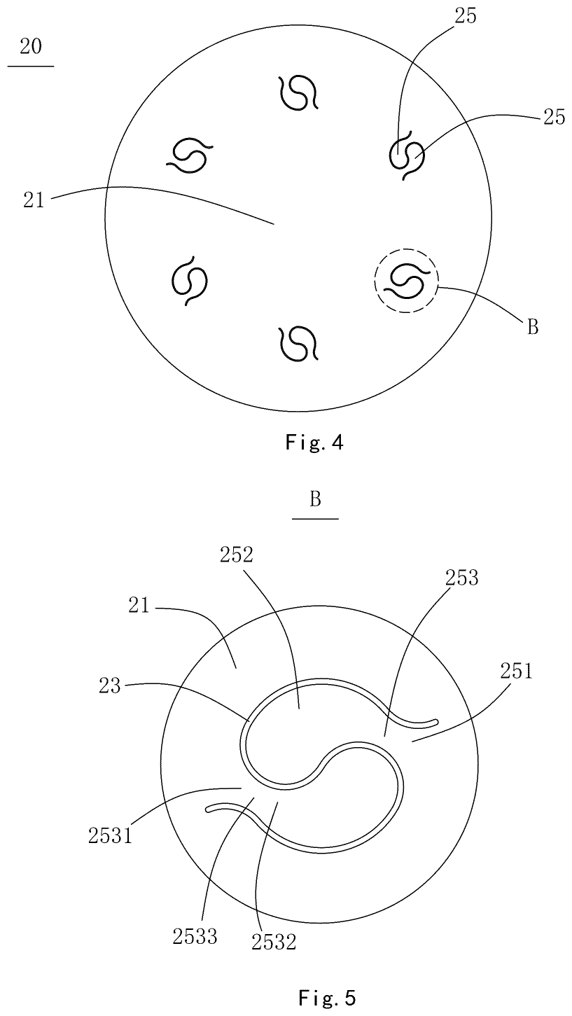

As shown in FIGS. 2-5, the diaphragm 20 includes a main body portion 21 located above the back cavity 11, a support portion 22 surrounding the main body portion 21 and mounted on the substrate 10, and a deflation valve 24 spaced apart from the main body portion 21 for forming a first venting slit 23. When the MEMS microphone chip 100 is in open state under normal pressure airflow, the deflation valve 23 is close. The first venting slit 23 is communicated with the back cavity 11 and the inner cavity 30 for ensuring good low-frequency performance of the MEMS microphone chip 100. As shown in FIG. 3, the deflation valve 24 is open for ensuring good air venting performance when the MEMS microphone chip 100 is in open state under high pressure airflow.

Furthermore, the deflation valve 24 includes at least one deflation plates 25. Each of the at least one the deflation plates 25 includes a fixation portion 251 connected with the main body portion 21, a move portion 252 arranged at an interval from the main body portion 21, and a connection portion 253 connected with the fixation portion 251 and the move portion 252. A width of the fixation portion 251 is smaller than a width of the move portion 252, thus reducing the stress concentration of a joint of the fixation portion 251 of the deflation valve 25 and the main body portion 21 of the diaphragm 20 and improving the reliability of the MEMS microphone chip 100 under high pressure airflow.

Besides, as shown in FIGS. 2-5, the deflation valve 24 includes two deflation plates 25. The two deflation plates 25 are arranged at an interval in a rotationally symmetrical manner. Specifically, the connection portion 253 includes a first connection portion 2531 fixed to the fixation portion 251, a second connection portion 2532 fixed to the move portion 252, and a third connection portion 2533 connected with the first connection portion 2531 and the second connection portion 2532. When the diaphragm 20 is pushed by the high pressure airflow, the deflation valve 24 moves towards the back plate 40. The second connection portions 2532 of the two deflation plates 25 are configured to contact with each other to achieve self-lock, thus suppressing the deformation of the deflation plate 25 under high-pressure airflow and further improving the reliability of the MEMS microphone chip 100 under high pressure airflow. Moreover, the connection portion 253 is in an arc shape. A width of the third connection portion 2533 is smaller than a width of the first connection portion 2531 and a width of the second connection portion 2532.

In addition, the back plate 40 includes a stop portion 41 extended from a surface facing the diaphragm 20 towards the diaphragm 20. The stop portion 41 is arranged opposite to the deflation valve 24. As shown in FIG. 3, When the deflation valve 24 moves towards the back plate 40 under high pressure airflow, the deflation valve 24 is limited by the stop portion 41 to avoid excessive displacement, thereby reducing the stress concentration of the deflation plate 25 and further improving the reliability of the MEMS microphone chip 100 under high pressure airflow.

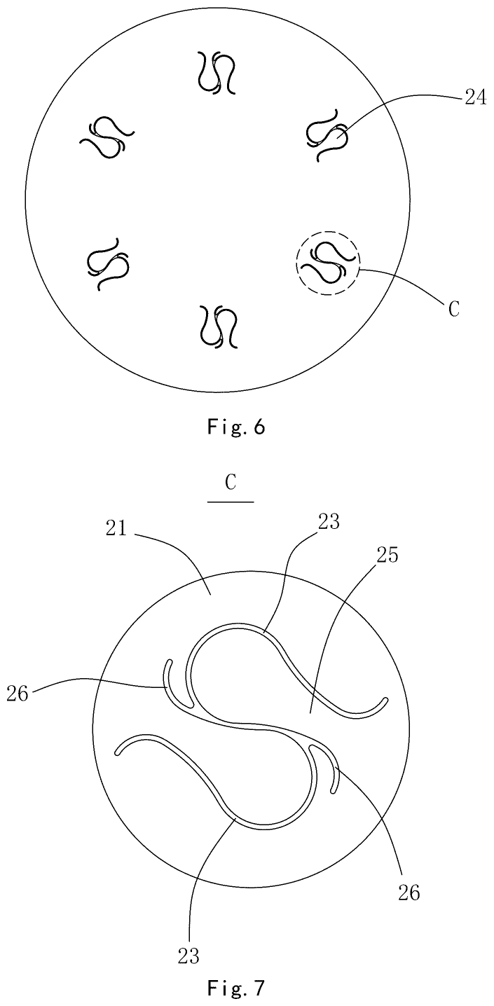

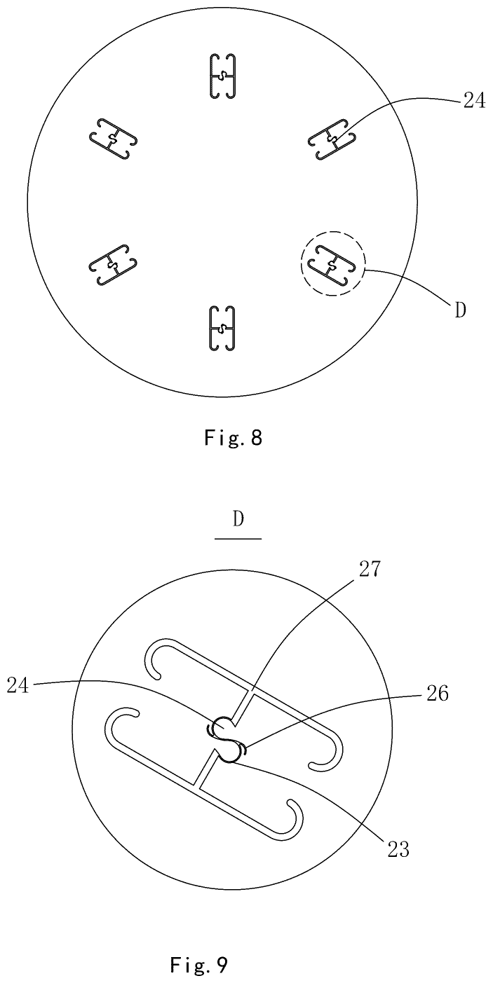

Furthermore, the diaphragm 20 includes a plurality of deflation valves 24 spaced apart from each other and arranged in an annular shape. As shown in FIGS. 6-7, a second venting slit 26 is provided on the diaphragm 20 penetrating thereon. The second venting slit 26 is communicated with the first venting slit 23 for further improving the deflation performance of the MEMS microphone chip 100. In one embodiment, a structural strength of the deflation plate 25 is greater than a structural strength of the main body portion 21.

For further improving the deflation performance of the MEMS microphone chip 100, a third deflation slit 27 is provided on the diaphragm 20 by penetrating thereon along the vibration direction. The third deflation slit 27 is communicated with the back cavity 11 and the inner cavity 30. To be specific, the third deflation slit 27 is connected with the first deflation slit 23 and located on at least one side of the deflation valve 24.

Compared with related art, the MEMS microphone chip 100 in the present disclosure includes a diaphragm having a support portion fixed on the substrate, a main body portion located above the back cavity, and a deflation valve spaced apart from the main body portion for forming a first deflation slit. The deflation valve includes at least one deflation plates. Each of the at least one deflation plates includes a fixation portion connected with the main body portion, a move portion arranged at an interval from the main body portion, and a connection portion connected with the fixation portion and the move portion. A width of the fixation portion is smaller than a width of the move portion. By providing a deflation plate with a narrow fixation portion and a wide move portion, the stress concentration on the joint of the main body portion and the deflation valve is effectively reduced, thus improving the reliability of the MEMS microphone chip 100 under high pressure airflow.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. An MEMS microphone chip comprising:
a substrate having a back cavity;
a diaphragm mounted on the substrate and located above the back cavity, including:
a main body portion located above the back cavity;
a support portion surrounding the main body portion and mounted on the substrate; and
a deflation valve spaced apart from the main body portion for forming a first venting slit; and
a back plate spaced apart from the diaphragm along a vibration direction forming an inner cavity there between; wherein
the deflation valve includes at least one deflation plates; each of the at least one the deflation plates includes a fixation portion connected with the main body portion, a move portion arranged at an interval from the main body portion, and a connection portion connected with the fixation portion and the move portion; a width of the fixation portion is smaller than a width of the move portion.

2. The MEMS microphone chip as described in claim 1, wherein the back plate comprises a stop portion extended from a surface facing the diaphragm towards the diaphragm; the stop portion is arranged opposite to the deflation valve.

3. The MEMS microphone chip as described in claim 1, wherein the connection portion is in an arc shape.

4. The MEMS microphone chip as described in claim 3, wherein the at least one deflation plates comprises two deflation plates; the two deflation plates are arranged at an interval in a rotationally symmetrical manner.

5. The MEMS microphone chip as described in claim 4, wherein the connection portion comprises a first connection portion fixed to the fixation portion, a second connection portion fixed to the move portion, and a third connection portion connected with the first connection portion and the second connection portion; the second connection portions of the two deflation plates are configured to contact with each other to achieve self-lock when the deflation valve moves towards the back plate.

6. The MEMS microphone chip as described in claim 5, wherein a width of the third connection portion is smaller than a width of the first connection portion and a width of the second connection portion.

7. The MEMS microphone chip as described in claim 1, wherein the diaphragm comprises a plurality of deflation valves spaced apart from each other and arranged in an annular shape.

8. The MEMS microphone chip as described in claim 1, wherein the diaphragm further comprises a second venting slit penetrating thereon; the second venting slit is communicated with the first venting slit.

9. The MEMS microphone chip as described in claim 1, wherein a structural strength of the deflation plate is greater than a structural strength of the main body portion.
